(19) United States
(12) Patent Application Publication
(10) Pub. No.: US 2005/0086283 A1
(43) Pub. Date: Apr. 21, 2005

(54) Method and system for dynamic web display

(76) Inventor: John Marshall, Stoney Creek (CA)

Correspondence Address: DEETH WILLIAMS WALL LLP, 150 YORK STREET, SUITE 400, TORONTO, M5H 3S5, CA

(21) Appl. No.: 10/926,974

(22) Filed: Aug. 27, 2004

Related U.S. Application Data
(60) Provisional application No. 60/497,915, filed on Aug. 27, 2003.

(51) Int. Cl. G06F 15/16

(52) U.S. Cl. 709/200

(57) ABSTRACT

A system for transacting retrieval of real estate property listing(s) over an information network and dynamically transmitting the listing(s), in near or real time, to one or more Flash banner(s) enabled with dynamic messaging technology residing on an ad server and the Flash banner(s) are posted on one or more Internet urls, comprising a set of real estate property listings maintained in a structured database, a database module. A target data set in an XML string compiled by a DynamicMLS engine describing one or more such listings for at least one such agent compiled by the database module upon initiation of a session; the listings matching the target data set from the structured database are then identified and retrieved by the Flash Banner enabled with dynamic messaging technology and displayed on one or more Flash banners residing on one or more publisher web sites and the Flash banners are posted on one or more url's upon termination of the session.

### FIELD OF THE INVENTION

The present invention relates to a method and system for displaying classified and inventory-based listings within a browser-displayed banner using Flash technology on an electronic network.

### BACKGROUND OF THE INVENTION

The use of databases for storing information relating to classified and inventory-based information has become wide acceptance. Not merely is its popularity due to its ability to provide information to professionals in the industry, but also its potential as a means of disseminating information quickly and widely by using other technologies. One such area of application relates to real estate property.

The information in a listing for a piece of property may include a number of elements, including its postal address, physical characteristics of the property including number and type of rooms, the realtor responsible for marketing the property, and images of the property such as photographs, videos, and even virtual tours.

All of these above information, or a substantial part thereof, may be provided to a person using the Internet, an extranet or an intranet, for display on a computer to the said person. The presented information may be static such as text or a photograph, or dynamic such a video stream; it may be not merely visual, but also multimedia in format.

### SUMMARY OF THE INVENTION

This invention provides for A system for dynamic web display at a browser on an electronic network of real estate data, comprising: a database containing a plurality of listings; a server with flash banners enabled with dynamic messaging technology in electronic communication with the database; a controller at the browser for receiving user input and inventory data from the ad server; wherein a target data set for the real estate data is compiled in an XML string describing one or more such listings for at least one agent by the database module; the listings matching the target data set from the database being retrieved by the Flash Banner are then displayed on at least one Flash banner residing on at least one publisher web sites and posted on at least one url's.

This invention also provides for a method for dynamic web display at a browser on an electronic network of real estate data, comprising the steps of: receiving a request at a server for real estate data; compiling a target data set for the real estate data in an XML string describing one or more listings for at least one agent by a database in electronic communication with the server; retrieving the listings matching the target data set from the database by the Flash Banner; and displaying the real estate data on at least one Flash banner residing on at least one publisher web sites.

This invention further provides for a system for transacting retrieval of real estate property listing(s) over an information network and dynamically transmitting the listing(s), in near or real time, to one or more Flash banner(s) enabled with dynamic messaging technology residing on an ad server and the Flash banner(s) are posted on one or more Internet urls, comprising: a set of real estate property listings is maintained in a structured database, each listing including a data record set describing property listing information organized according to individual real estate agent, the data record set containing all information comprising ad display duration time, publisher selection, campaign ID, campaign duration, listing details; a database module interfaced in a dynamic search session via a communications link connected over an information network, the database module maintaining both program code and data in a general purpose random access memory configured for both transient and persistent storage; and a target data set in an XML string compiled by a DynamicMLS engine describing one or more such listings for at least one such agent compiled by the database module upon initiation of a session; the listings matching the target data set from the structured database being then identified and retrieved by the Flash Banner enabled with dynamic messaging technology and displayed on one or more Flash banners, residing on one or more publisher web sites and the Flash banners are posted on one or more urn's upon termination of the session.

### DETAILED DESCRIPTION OF THE INVENTION

Although the following discussion are directed mostly to real estate property listings, it would be clear to a person in the art that any classified and inventory-based listings such as for cars/autos, jobs/recruitment, personals and travel are within the scope of this invention.

According to one embodiment of this invention, a customized inventory repository server is connected to an information network (such as the Internet), accepting inventory data from an advertiser via a real-time feed or data input device. The technology provides for a unique method of displaying graphic (incl. photographs) and textual descriptions of each listing, as well as branding information for agents and brokers. It simplifies and expedites the process of producing online listing ads and is able to generate more web exposure (impressions) than traditional banner ads.

The inventory data may contain plural text data, numeric data, images, multiple URLs, rich media (including, but not limited to, creative artwork, streaming banners, video, and audio clips), as well as directives on how, where, and when the inventory data is to be presented on a rich media advertisement. Each listing includes a data record set describing property listing information organized according to individual real estate agent. The data record set contains all information such as ad display duration time, publisher selection, campaign ID, campaign duration, listing(s) details.

Prior to inventory data being rendered for display on the Internet on a web page, it may undergo a conditionally, multi-step approval process, which is a workflow allowing advertisers and administrators to verify data integrity and appropriateness. If inventory data is being fed from a trusted source, the approval process can be waived for immediate release on rich media advertisements.

Inventory data is presented to a user running a browser on the information network. Running on each browser that renders inventory data in a rich media advertisement is a customized software component called the Controller, which fetches inventory data and customized rendering instructions, interpolates this data into an advertisement, and records and acts upon user interactions (render counts, mouse and keyboard activity). Inventory data is formatted and displayed, one item at a time, using various graphical transitioning techniques.

Campaign delivery servers are connected to the information network. They receive requests from the browser-based Controller for inventory data and rendering instructions, and streams the data back via standard protocols. Inventory is selected from the inventory repository server according to advertisement placement, targeting campaigns, and pre-defined randomization and weighting rules.

A preferred embodiment of this invention displays multiple listings within a Flash banner.

The components of the preferred embodiment include a central database running on a computer accepting listing updates on a real time basis, a client campaign management tool, a system administrator module, an ad server, and a Flash banner that drives the display of multiple listings that is embedded in a webpage.

Listings can either be entered into the system by each agent using a controlled secure web interface (Controller), or in bulk fashion by processing uploads from a broker. As mentioned earlier, listings may move through a workflow to verify correctness, ensure that the content and photos are appropriate, and for final approval.

Unlike existing ad services, a person entering listing information need only provide listing descriptions and photos and not have to worry about artistic content. As a result, production costs are greatly reduced.

Listings are grouped together in “campaigns”, and campaigns are targeted for display on one or more web properties. Each campaign may have custom Flash creative content that further enhances the visual effects of an advertising banner.

When the Ad Server receives a request from an embedded banner ad of this invention, it selects all relevant customer campaigns, retrieves all listings, randomly shuffles them, and preferably generates an XML stream containing information on what listings to render and in what formats. A target data set in an XML string describing one or more such listing(s) for at least one such agent is compiled by the central database upon initiation of a session. The listing(s) matching the target data set from the database are identified and then retrieved by the Flash Banner enabled with dynamic messaging technology and displayed on one or more Flash banner(s), residing on one or more publisher web sites and the Flash banner(s) are posted on one or more URL's upon termination of the session. It dynamically transmits the listing(s), in near or real time, to the requester.

By default, all listings have equal exposure on the targeted web properties, although listings can be weighted for more or less exposure on various web properties.

Owners of listings are able to check the exposure (impressions) that a listing has had, as well as determine how many users “click-thru” the ad to get more listing details at a pre-specified web address.

The central database is able to serve (approved) new and updated listings to the Ad Server for immediate display on targeted web properties.

It will be appreciated that the above description relates to the preferred embodiments by way of example only. Many variations on the system and method for delivering the invention without departing from the spirit of same will be clear to those knowledgeable in the field, and such variations are within the scope of the invention as described and claimed, whether or not expressly described.

1. A system for dynamic web display at a browser on an electronic network of real estate data, comprising:
a database containing a plurality of listings;
a server with flash banners enabled with dynamic messaging technology in electronic communication with the database;
a controller at the browser for receiving user input and inventory data from the ad server;
wherein a target data set for the real estate data is compiled in an XML string describing one or more such listings for at least one agent by the database module; the listings matching the target data set from the database being retrieved by the Flash Banner are then displayed on at least one Flash banner residing on at least one publisher web sites and posted on at least one url's.

2. The system of claim 1, wherein each of the listings comprises a data record set describing property listing information organized according to individual real estate agent, the data record set containing all information comprising ad display duration time, publisher selection, campaign ID, campaign duration, and listing details.

3. The system of claim 1, further comprising a client campaign management tool and a system administrator module.

4. The system of claim 1, wherein the listings matching the target data set are of a single campaign.

5. The system of claim 1, wherein the listings matching the target data set have variable display exposure.

6. A method for dynamic web display at a browser on an electronic network of real estate data, comprising the steps of:
receiving a request at a server for real estate data;
compiling a target data set for the real estate data in an XML string describing one or more listings for at least one agent by a database in electronic communication with the server;
retrieving the listings matching the target data set from the database by the Flash Banner; and
displaying the real estate data on at least one Flash banner residing on at least one publisher web sites.

7. The method of claim 6, wherein each of the listings comprises a data record set describing property listing information organized according to individual real estate agent, the data record set containing all information comprising ad display duration time, publisher selection, campaign ID, campaign duration, and listing details.

8. The method of claim 6, further comprising a client campaign management tool and a system administrator module.

9. The method of claim 6, wherein the listings matching the target data set are of a single campaign.

10. The method of claim 6, wherein the listings matching the target data set have variable display exposure.

11. A system for transacting retrieval of real estate property listing(s) over an information network and dynamically transmitting the listing(s), in near or real time, to one or more Flash banner(s) enabled with dynamic messaging technology residing on an ad server and the Flash banner(s) are posted on one or more Internet urls, comprising:
a set of real estate property listings is maintained in a structured database, each listing including a data record set describing property listing information organized according to individual real estate agent, the data record set containing all information comprising ad display duration time, publisher selection, campaign ID, campaign duration, listing details;
a database module interfaced in a dynamic search session via a communications link connected over an information network, the database module maintaining both program code and data in a general purpose random access memory configured for both transient and persistent storage; and
a target data set in an XML string compiled by a DynamicMLS engine describing one or more such listings for at least one such agent compiled by the database module upon initiation of a session; the listings matching the target data set from the structured database being then identified and retrieved by the Flash Banner enabled with dynamic messaging technology and displayed on one or more Flash banners, residing on one or more publisher web sites and the Flash banners are posted on one or more urn's upon termination of the session.

12. The system of claim 11, further comprising a client campaign management tool and a system administrator module.

13. The system of claim 11, wherein the listings matching the target data set are of a single campaign.

14. The system of claim 11, wherein the listings matching the target data set have variable display exposure.
